(19) United States
(12) Patent Application Publication
(10) Pub. No.: US 2008/0077639 A1
(43) Pub. Date: Mar. 27, 2008

(54) Information processing apparatus

(75) Inventors: Yoshiyuki Tanaka, Hino-shi (JP); Koichi Zenke, Sapporo-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/897,502

(22) Filed: Aug. 30, 2007

(30) Foreign Application Priority Data
Aug. 30, 2006 (JP) 2006-234273

(51) Int. Cl. G06F 17/30

(52) U.S. Cl. 707/205; 707/E17.009

(57) ABSTRACT

The invention provides an information processing apparatus that includes: a file management information acquisition unit that acquires file management information, which is information for managing content files, the file management information having the managed content files registered therein and having an album defined therein, the content files being registered as one group in the album for management thereof; a content file identification unit that identifies the content files registered in the file management information on the basis of the acquired file management information; a first unregistered extraction unit that extracts a content file that is not registered in any of the albums as unregistered content file on the basis of the acquired file management information; and a first virtual album registration unit that creates a first virtual album and registers the unregistered content file that is extracted by the first unregistered extraction unit into the created first virtual album.

The entire disclosure of Japanese Patent Application No. 2006-234273, filed Aug. 30, 2006 is expressly incorporated by reference herein.

### BACKGROUND

1. Technical Field

The present invention generally relates to an information processing apparatus. More particularly, the present invention relates to an information processing apparatus that is capable of managing content files by means of file management information.

2. Related Art

Recently, with the increasing popularity of various types of content sources such as digital cameras, digital music distributed over the Internet, or the like, it has become more frequent for individual users to manage content files for themselves. Thanks to the increasing number of mass-storage removable recording media that are commercially available such as a CD-R, DVD, just to name but a few, general users can handle a very large number of content files in a quite easy manner nowadays. In an aim to improve compatibility among various types of information processing apparatuses that handle content files and to make file management friendlier to users, file management information format standards have been established so far. A typical example of such format standards is an MPV (Music Photo/Video) (registered trademark), which is a standard proposed by OSTA (Optical Storage Technology Association).

A technique that achieves efficient file management and improved user-friendliness with the adoption the technical standard described above is disclosed in, for example, JP-A-2005-327257.

In the MPV, which is also described in the above patent publication, it is specified that content files are defined as assets, the metadata of which are defined in a manifest. In the asset list of the manifest, it is specified to declare assets that are active in the medium. In addition, it is possible to further define the album list of albums, which is a group of play lists (Album, Malklist) and/or link references to albums (AlbumRef, ManifestLink) in the manifest. As these definitions are displayed on a screen as an album selection window, a user can easily narrow a bulk of assets contained in the medium down to a significantly smaller number of assets they need, and plays (i.e., reproduces) the selected assets. In actual implementation, it is not the assets themselves but link information for referencing specific assets registered in the asset list that is described (i.e., written) in the album list.

In some cases, the asset list could include some assets that have no link to any album at all. Such an unlinked asset is hereafter referred to as unregistered (i.e., uncataloged) asset. Disadvantageously, it is impossible for a user to select the unregistered asset no matter what albums are referred to.

If an album selected by a user contains a link for referencing any other album(s) (AlbumRef, ManifestLinkRef), a sub album selection window in which the link target album is shown as a sub album, which is one of choices, is displayed on a screen so as to allow the user to select any one of a plurality of sub albums. Disadvantageously, however, in such an album containing a link for referencing any other album (i.e., a link to any other album), even if the album in question contain information on link to assets, such assets are never referenced. This means that opportunities for referencing these assets are lost. For this reason, in addition to the aforementioned case, these assets also constitute unregistered assets.

### SUMMARY

An advantage of some aspects of the invention is to provide an information processing apparatus that secures opportunities for referencing unregistered assets.

In order to address the above-identified problems without any limitation thereto, an information processing apparatus according to a first aspect of the invention includes: a file management information acquisition section that acquires file management information, which is information for managing content files, the file management information having the managed content files registered therein and having an album defined therein, the content files being registered as one group in the album for management thereof; a content file identification section that identifies the content files registered in the file management information on the basis of the acquired file management information; a first unregistered extraction section that extracts a content file that is not registered in any of the albums as unregistered content file on the basis of the acquired file management information; and a first virtual album registration section that creates a first virtual album and registers the unregistered content file that is extracted by the first unregistered extraction section into the created first virtual album.

It is preferable that the information processing apparatus having a configuration described above further includes a first album selection window display section that displays a first album selection window that shows the album defined in the file management information and further shows the first virtual album that is created by the first virtual album registration section as choices.

It is preferable that the information processing apparatus having a configuration described above further includes a first list display section that displays the unregistered content files that are registered in the first virtual album by the first virtual album registration section as a list when a user selects the first virtual album on the first album selection window displayed by the first album selection window display section.

It is preferable that the information processing apparatus having a configuration described above further includes: a second unregistered extraction section that extracts a content file as unregistered content file if, in the file management information, the album is defined by linking to another album in the album selected by the user, and further if a registered content file is also present in the album selected by the user; and a second virtual album registration section that creates a second virtual album and registers the unregistered content file that is extracted by the second unregistered extraction section into the created second virtual album.

It is preferable that the information processing apparatus having a configuration described above further includes a second album selection window display section that displays a second album selection window that shows the album defined by linking to another album in the album selected by the user, and further shows the second virtual album that is created by the second virtual album registration section as choices.

It is preferable that the information processing apparatus having a configuration described above further includes a second list display section that displays the unregistered content files that are registered in the second virtual album by the second virtual album registration section as a list when a user selects the second virtual album on the second album selection window displayed by the second album selection window display section.

In the information processing apparatus having a configuration described above, it is preferable that the file management information is described in an MPV (Music Photo/Video) format.

In order to address the above-identified problems without any limitation thereto, an information processing apparatus according to a second aspect of the invention includes: a file management information acquisition section that acquires file management information, which is information for managing content files, the file management information having the managed content files registered therein and having an album defined therein, the content files being registered as one group in the album for management thereof; an unregistered extraction section that extracts a content file as unregistered content file if, in the file management information, the album is defined by linking to another album in the album selected by a user, and further if a registered content file is also present in the album selected by the user; and a virtual album registration section that creates a virtual album and registers the unregistered content file that is extracted by the unregistered extraction section into the created virtual album.

### BRIEF DESCRIPTION OF THE DRAWINGS

The invention will be described with reference to the accompanying drawings, wherein like numbers reference like elements.

FIG. 1 is a block diagram that illustrates an example of the inner configuration of an information processing apparatus according to an embodiment of the invention.

FIG. 2 is a partial diagram that illustrates an example of a tag of an asset list in a manifest stored in a recording medium.

FIG. 3 is a partial diagram that illustrates an example of a tag of an album in a manifest stored in a recording medium.

FIG. 4 is a flowchart that illustrates an example of an album selection window display processing that is performed by an information processing apparatus according to an embodiment of the invention.

FIG. 5 is a diagram that illustrates an example of an album selection window that is displayed on the display screen of an information processing apparatus.

FIG. 6 is a partial diagram that illustrates an example of a tag of an album in a manifest stored in a recording medium.

FIG. 7 is a flowchart that illustrates an example of a sub album selection window display processing that is performed by an information processing apparatus according to an embodiment of the invention.

FIG. 8 is a diagram that illustrates an example of a sub album selection window that is displayed on the display screen of an information processing apparatus.

### DESCRIPTION OF EXEMPLARY EMBODIMENTS

With reference to the accompanying drawings, an exemplary embodiment of the invention is explained below. Needless to say, it should be noted that the exemplary embodiment of the invention described below has no intention to limit the technical scope of the invention.

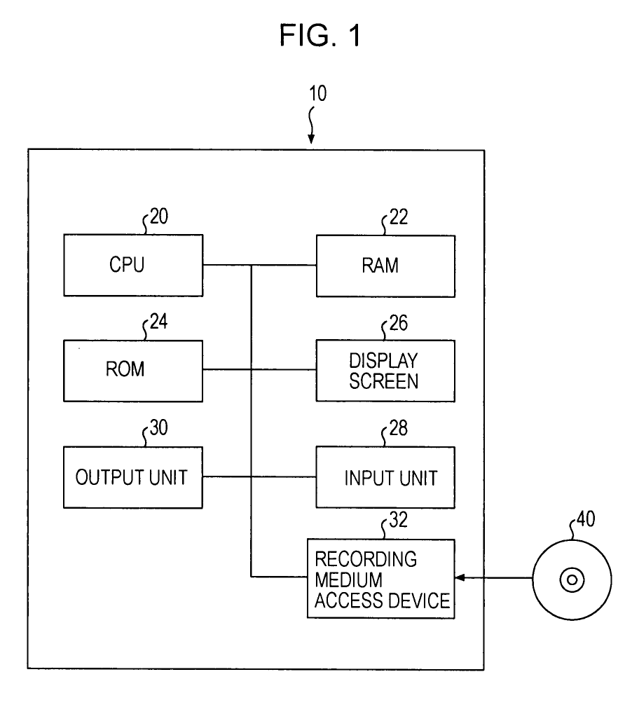

FIG. 1 is a block diagram that illustrates an example of the inner configuration of an information processing apparatus 10 according to the present embodiment of the invention. As illustrated in FIG. 1, the information processing apparatus 10 according to this exemplary embodiment of the invention is provided with a CPU (Central Processing Unit) 20, a RAM (Random Access Memory) 22, a ROM (Read Only Memory) 24, a display screen 26, an input unit 28, an output unit 30, and a recording medium access device 32. These components are connected to one another via an internal bus. In this exemplary embodiment of the invention, the information processing apparatus 10 is configured as a printer such as an ink-jet printer, a laser printer, or the like.

The CPU 20 constitutes the control section of the information processing apparatus 10. The CPU 20 reads out various kinds of programs stored in, for example, the ROM 24 to execute thereof. The RAM 22 is a memory in which data that is used when the CPU 20 performs various kinds of processing is stored in a volatile manner. The display screen 26 is configured as, for example, a small liquid crystal display screen. The input unit 28 may be configured as, for example, an operation panel having cursor buttons and a decision button. Or, alternatively, the input unit 28 and the display screen 26 may be configured as a single integrated unit if the display screen 26 is configured as a touch panel. The output unit 30, which is configured as an ink-jet printer engine, a laser printer engine, or the like, performs printing on a print target object in accordance with control instructions given by the CPU 20.

A recording medium 40 is detachably inserted into the recording medium access device 32. The recording medium access device 32 enables the information processing apparatus 10 to read data that is stored in the recording medium 40. The recording medium access device 32 may be configured to be capable of writing data into the recording medium 40. The recording medium 40 may be embodied in a variety of media types including but not limited to a CD-ROM, CD-R, DVD, compact flash (registered trademark), or SD memory card.

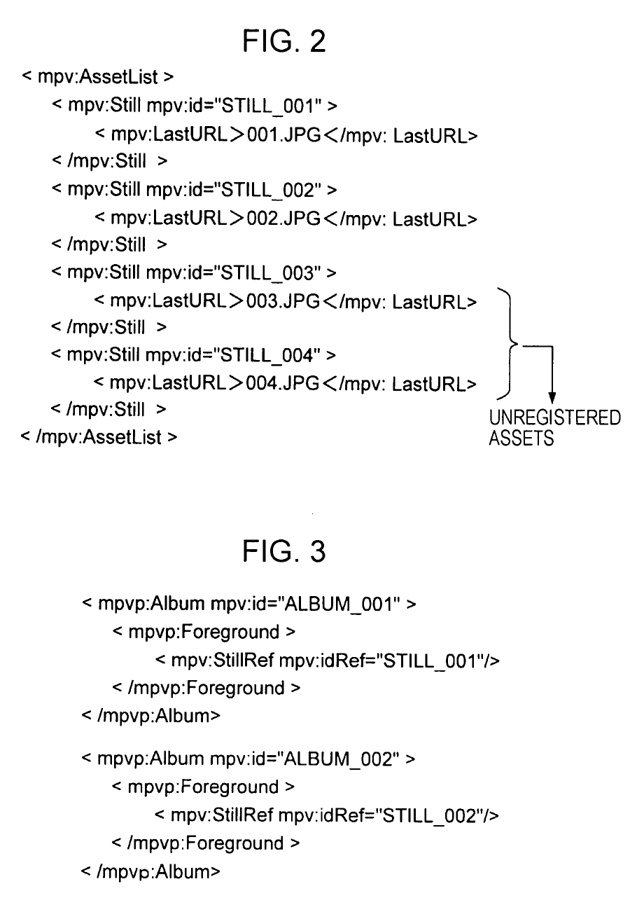

First of all, an explanation is given of processing that is performed by the information processing apparatus 10 shown in FIG. 1 when some unregistered assets are present. FIG. 2 is a diagram that illustrates an example of the essential part of an asset list when some unregistered assets are present. FIG. 3 is a diagram that illustrates an example of an album. In the following explanation, it is assumed that, for example, it is only the album illustrated in FIG. 3 that is present in the MPV-format manifest stored in the recording medium 40 although the asset list illustrated in FIG. 2 is present therein.

In the asset list illustrated in FIG. 2, four image files of “001. JPG”, “002. JPG”, “003. JPG”, and “004. JPG” are declared as assets. Identifiers (ID) “STILL_{—}001”, “STILL_{—}002”, “STILL_{—}003”, and “STILL_{—}004” are affixed to these image files “001. JPG”, “002. JPG”, “003. JPG”, and “004. JPG”, respectively. In the album illustrated in FIG. 3, although two of the IDS, specifically, “STILL_{—}001” and “STILL_{—}002” are referenced, the other two IDS “STILL_{—}003” and “STILL_{—}004” are not referenced. In other words, in the manifest of the recording medium 40, although the image files “001. JPG” and “002. JPG” are referenced, the image files “003. JPG” and “004. JPG” are never referenced. Therefore, the image files “003. JPG” and “004. JPG” constitute unregistered assets in this example.

If no measures are taken, a user will never reach (i.e., have access to) the image files “003. JPG” and “004. JPG” as a result of their album selections that are made on an album selection window. Therefore, the user will never know the presence of the image files “003. JPG” and “004. JPG”. In order to address such a problem without any limitation thereto, in the present embodiment of the invention, a virtual album is created for registration of the image files “003. JPG” and “004. JPG” therein. The invention ensures these two assets, that is, the image files “003. JPG” and “004. JPG”, are referenced by registering these content files in the created virtual album.

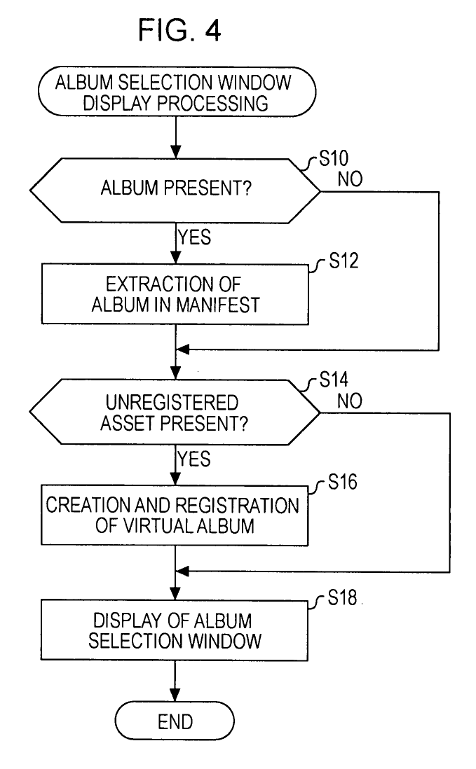

FIG. 4 is a flowchart that illustrates album selection window display processing that is carried out by the information processing apparatus 10 according to the present embodiment of the invention. This processing flow includes the registration of unregistered assets into a virtual album. The album selection window display processing is performed when the CPU 20 reads the album selection window display processing program stored in the ROM 24 for execution thereof. Note that the album selection window display processing program is automatically run when a user inserts the recording medium 40 into the recording medium access device 32.

As the first step, as illustrated in FIG. 4, the information processing apparatus 10 acquires a manifest stored in the recording medium 40, and then judges whether any album is registered therein (step S10). If any album is registered in the manifest (step S10: Yes), all of the albums registered in the manifest are extracted (step S12). On the other hand, if no album is registered in the manifest (step S10: No), the step S12 is skipped.

Next, the information processing apparatus 10 judges whether there is any unregistered asset contained in the recording medium 40 or not (step S14). In other words, in the step S14, the information processing apparatus 10 judges whether there is any asset that is not registered in the album although it is/they are declared in the asset list.

If any unregistered asset is present therein (the step S14: Yes), one virtual album is created. Then, the unregistered assets are registered in the created virtual album (step S16). On the other hand, if no unregistered asset is present (step S14: No), the step S16 is skipped.

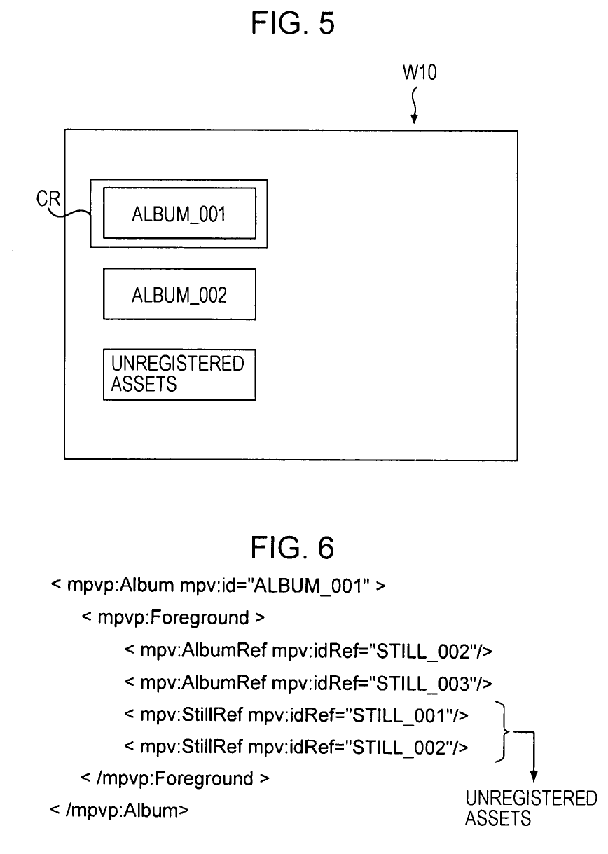

Next, the information processing apparatus 10 displays an album selection window on the display screen 26 (step S18). FIG. 5 is a diagram that illustrates an example of an album selection window W10 that is displayed on the display screen 26. In the manifest illustrated in FIGS. 2 and 3, two albums “ALBUM_{—}001” and “ALBUM_{—}002” are defined. Therefore, these two albums “ALBUM_{—}001” and “ALBUM_{—}002” are displayed on the album selection window W10 as choices.

Since two content files “003. JPG” and “004. JPG” are unregistered assets, a virtual album in which these two image files are registered is displayed as “unregistered asset”.

The album selection window display processing according to the present embodiment of the invention ends after displaying the album selection window. In actual implementation, however, the user performs album selection manipulations thereafter on the basis of the displayed album selection window. That is, the user moves a cursor CR by means of a cursor button of the input unit 28 and then depresses a decision button thereof so as to select their desired album.

For example, when the user selects “ALBUM_{—}001” on the album selection window W10 illustrated in FIG. 5, the content file “001. JPG” is displayed as an asset list item so as to make it possible for the user to select this file (“001. JPG”). When the user selects “ALBUM_{—}002” thereon, the content file “002. JPG” is displayed as an asset list item so as to make it possible for the user to select this file (“002. JPG”). When the user selects “unregistered asset” thereon, the content files “003. JPG” and “004. JPG” are displayed as asset list items so as to make it possible for the user to select these files (“003. JPG” and “004. JPG”). In other words, it becomes possible for the user to select the content files “003. JPG” and “004. JPG”, which are unregistered assets, on the album selection window W10.

In the above explanation, an MPV Album tag is taken as an example of an album. It should be noted that, however, MarkList tag is also extracted as the album in the step S12 because the MarkList tag functions in the same manner as the album.

Next, an explanation is given of processing that is performed by the information processing apparatus 10 according to the present embodiment of the invention when some unregistered assets are present in sub albums. FIG. 6 is a diagram that illustrates an example of the essential part of a manifest when some unregistered assets are present in sub album. In the manifest illustrated in FIG. 6, tags for referencing other albums “ALBUM_{—}002” and “ALBUM_{—}003” are defined as sub albums contained in the album “ALBUM_{—}001”. For this reason, in the album “ALBUM_{—}001”, a user cannot have access to assets having IDs of “STILL_{—}001” and “STILL_{—}003” from the album selection window.

In order to address such a problem without any limitation thereto, in the present embodiment of the invention, a virtual album is created for registration of “STILL_{—}001” and “STILL_{—}002” therein. Then, “STILL_{—}001” and “STILL_{—}002” are registered in the created virtual album. By this means, the invention makes it possible to reference these two assets. If there is any tag in an album in question that references other album, regardless of whether a tag that references assets is present before the tag that references other album or the tag that references assets is present after the tag that references other album, the assets constitute unregistered ones.

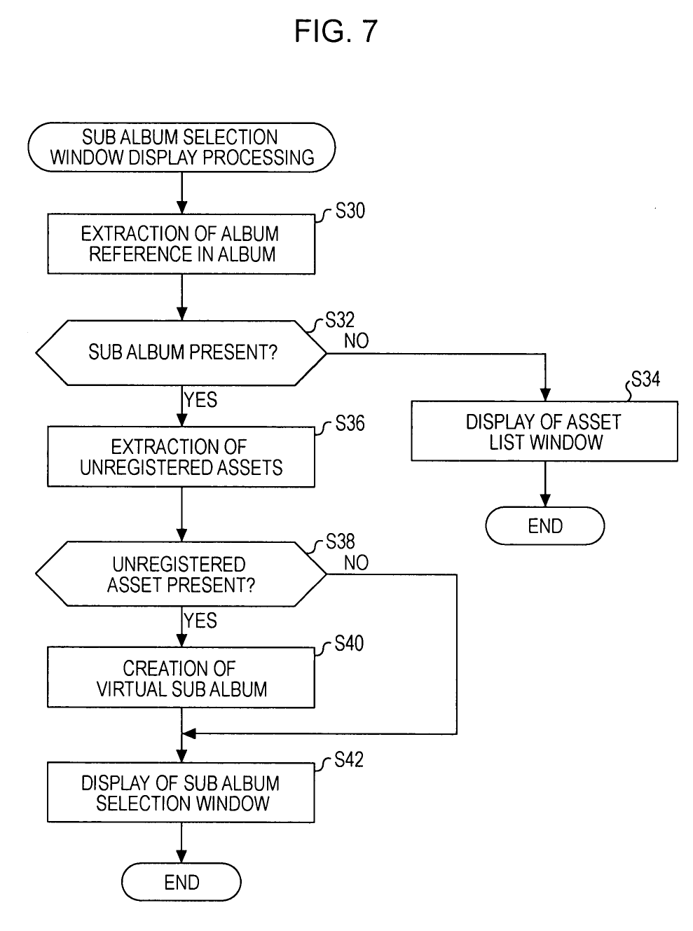

FIG. 7 is a flowchart that illustrates sub album selection window display processing that is carried out by the information processing apparatus 10 according to the present embodiment of the invention. This processing flow includes the registration of unregistered assets that are present in the sub album into a virtual album. The sub album selection window display processing is performed when the CPU 20 reads the sub album selection window display processing program stored in the ROM 24 for execution thereof. The sub album selection window display processing program is run at the time when a user selects an album on the album selection window.

As illustrated in FIG. 7, first of all, the information processing apparatus 10 extracts album reference contained in an album selected by the user (step S30). That is, the information processing apparatus 10 extracts sub albums contained in the user-selected album.

Next, the information processing apparatus 10 judges whether there is any sub album contained in the user-selected album or not (step S32). If there is no sub album contained therein (the step S32: No), the information processing apparatus 10 displays an asset list window on the display screen 26 (step S34) and then ends the sub album selection window display processing. That is, since assets are determined (i.e., decided/fixed) in this case, the information processing apparatus 10 displays a list of the determined assets so as to allow the user to make selection.

On the other hand, if there are some sub albums contained in the user-selected album (the step S32: Yes), the information processing apparatus 10 extracts unregistered assets (step S36). That is, if there is any tag that links to other album in the user-selected album, and further if there is any tag that references assets in the user-selected album, the information processing apparatus 10 extracts the referenced assets.

Next, the information processing apparatus 10 judges whether unregistered assets are present or not (step S38). In other words, the information processing apparatus 10 judges whether any unregistered asset has been extracted in the step S36.

If any unregistered asset is present therein (the step S38: Yes), one virtual album is created. Then, the unregistered assets are registered in the created virtual album (step S40). On the other hand, if no unregistered asset is present (step S38: No), the step S40 is skipped.

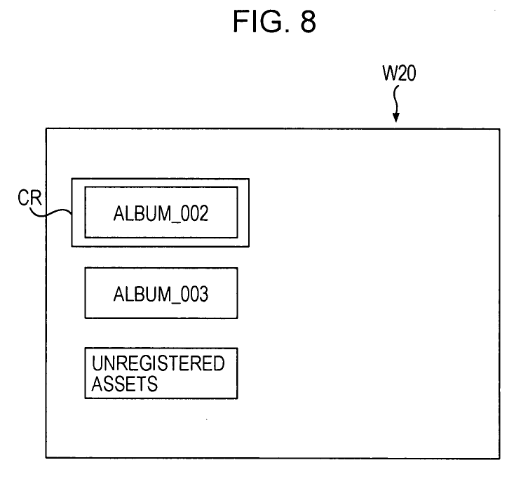

Next, the information processing apparatus 10 displays a sub album selection window on the display screen 26 (step S42). FIG. 8 is a diagram that illustrates an example of a sub album selection window W20 that is displayed on the display screen 26. In the manifest illustrated in FIG. 6, links to other albums “ALBUM_{—}002” and “ALBUM_{—}003” are defined in the album selected by the user. Therefore, “ALBUM_{—}002” and “ALBUM_{—}003” are displayed on the sub album selection window W20 as album choices. In addition, the virtual album created in the step S40 is displayed as “unregistered asset”.

The sub album selection window display processing according to the present embodiment of the invention ends after displaying the sub album selection window. In actual implementation, however, the user performs album selection manipulations thereafter on the basis of the displayed sub album selection window. That is, the user moves the cursor CR by means of the cursor button of the input unit 28 and then depresses the decision button thereof so as to select their desired album.

For example, if the user selects “ALBUM_{—}002” on the sub album selection window W20 illustrated in FIG. 8, the content of “ALBUM_{—}002” is displayed thereon. If the user selects “ALBUM_{—}003” on the sub album selection window W20, the content of “ALBUM_{—}003” is displayed thereon. On the other hand, if the user selects “unregistered asset” on the sub album selection window W20, the assets having IDs “STILL_{—}001” and “STILL_{—}002” are displayed as a list. This makes it possible for the user to select these assets. In other words, it becomes possible for the user to select the assets having IDs “STILL_{—}001” and “STILL_{—}002”, which are unregistered assets, on the sub album selection window W20.

In the above explanation, an MPV AlbumRef tag is taken as an example of a tag that links to other album. It should be noted that, however, since a ManifestLinkRef tag also links to other album, if the ManifestLinkRef tag is present in the album selected by the user, assets referenced in this album are extracted as unregistered assets in the step S36.

As explained above, according to the information processing apparatus 10 of the present embodiment of the invention, a virtual album is created if any unregistered assets that are not referenced to other album are present in the asset list. Then, the unregistered assets are registered in the virtual album. Subsequently, the virtual album is displayed on the album selection window W10 as a choice that a user can select. Therefore, the user can select the unregistered assets without requiring any special manipulation on the album selection window W10. This makes it possible for the user to easily find their desired asset (i.e., search target asset) even when it is not registered in the album.

If there are any sub albums in the album selected by the user, where the sub album is a link to other album, and further if there is any tag that references assets in the user-selected album, the assets constitute unregistered ones. In order to provide a technical solution therefor, according to the information processing apparatus 10 of the present embodiment of the invention, a virtual album is created; and then, the unregistered assets are registered in the virtual album. Subsequently, the virtual album is displayed on the sub album selection window W20 as a choice that the user can select. Therefore, the user can select the unregistered assets without requiring any special manipulation on the sub album selection window W20. This makes it possible for the user to easily find their desired asset even when it constitutes the unregistered assets in the sub album.

It should be noted that the invention is in no case limited to the above exemplary embodiment but may be modified, adapted, changed, or improved in a variety of modes in its actual implementation. As a variation example thereof, although a printer is taken as an example of the information processing apparatus 10 in the exemplary embodiment described above, the information processing apparatus 10 may be embodied as a personal computer, a mobile phone, a PDA (Personal Digital Assistant) without any limitation thereto.

As another variation example thereof, although image files are taken as an example of various kinds of content files in the exemplary embodiment of the invention described above because the information processing apparatus 10 is assumed to be a printer, the invention is not limited to such a specific example. That is, the invention is applicable to various kinds of content files in accordance with data handled by the information processing apparatus 10.

As still another variation example thereof, although the MPV is adopted as a description format of file management information in the exemplary embodiment of the invention described above, the invention is not limited to such a specific example. That is, the invention is applicable in the same manner even when any other description format is adopted for creation of the file management information.

As still another variation example thereof, although it is explained in the exemplary embodiment of the invention described above that the information processing apparatus 10 is capable of performing both the album selection window display processing shown in FIG. 4 and the sub album selection window display processing shown in FIG. 7, the invention is not limited to such a configuration. That is, either one thereof may be normal display processing. That is, the invention may be modified such that a virtual album is not created in the album selection window display processing, or that it is not created in the sub album selection window display processing.

As for each of the album selection window display processing and the sub album selection window display processing explained in the above exemplary embodiment of the invention, it is possible to store a program for executing each of these processing in a recording medium including but not limited to a CD-ROM, CD-R, DVD, compact flash, or SD memory card so as to distribute the program in the form of such a variety of storage media. In such a configuration, the program stored in the recording medium is read by the information processing apparatus 10 for execution thereof. By this means, the exemplary embodiment of the invention described above is implemented.

Other program such as operating system and/or other application program may be installed on the information processing apparatus 10. In such a configuration, in order to utilize other program installed on the information processing apparatus 10, it may be configured to store, into a recording medium, a program that includes a command for calling up another program that performs processing equivalent to one performed in the exemplary embodiment described above among programs installed on the information processing apparatus 10.

As still another variation example thereof, such a program may be distributed in the form of not a recording medium but a carrier via a network. A program transmitted over the network in the form of a carrier is received by the information processing apparatus 10. Then, the exemplary embodiment of the invention described above is implemented by executing the received program.

The program may be encrypted/encoded and/or compressed when it is stored into a recording medium or when it is transmitted as a carrier over a network. If it is encrypted and/or compressed, after reading the program obtained in the form of a recording medium or a carrier, the information processing apparatus 10 needs to decrypt/decode and/or decompress the program prior to execution thereof.

As still another variation example thereof, although it is explained in the exemplary embodiment described above that each processing is carried out by means of software, the invention is in no case restricted thereto. That is, each of these processing may be performed by means of hardware such as ASIC (Application Specific Integrated Circuit) or the like.

What is claimed is:

1. An information processing apparatus comprising:
a file management information acquisition section that acquires file management information, which is information for managing content files, the file management information having the managed content files registered therein and having an album defined therein, the content files being registered as one group in the album for management thereof;
a content file identification section that identifies the content files registered in the file management information on the basis of the acquired file management information;
a first unregistered extraction section that extracts a content file that is not registered in any of the albums as unregistered content file on the basis of the acquired file management information; and
a first virtual album registration section that creates a first virtual album and registers the unregistered content file that is extracted by the first unregistered extraction section into the created first virtual album.

2. The information processing apparatus according to claim 1, further comprising a first album selection window display section that displays a first album selection window that shows the album defined in the file management information and further shows the first virtual album that is created by the first virtual album registration section as choices.

3. The information processing apparatus according to claim 2, further comprising a first list display section that displays the unregistered content files that are registered in the first virtual album by the first virtual album registration section as a list when a user selects the first virtual album on the first album selection window displayed by the first album selection window display section.

4. The information processing apparatus according to claim 1, further comprising:
a second unregistered extraction section that extracts a content file as unregistered content file if, in the file management information, the album is defined by linking to another album in the album selected by the user, and further if a registered content file is also present in the album selected by the user; and
a second virtual album registration section that creates a second virtual album and registers the unregistered content file that is extracted by the second unregistered extraction section into the created second virtual album.

5. The information processing apparatus according to claim 4, further comprising a second album selection window display section that displays a second album selection window that shows the album defined by linking to another album in the album selected by the user, and further shows the second virtual album that is created by the second virtual album registration section as choices.

6. The information processing apparatus according to claim 5, further comprising a second list display section that displays the unregistered content files that are registered in the second virtual album by the second virtual album registration section as a list when the user selects the second virtual album on the second album selection window displayed by the second album selection window display section.

7. The information processing apparatus according to claim 1, wherein the file management information is described in an MPV (Music Photo/Video) format.

8. An information processing apparatus comprising:
a file management information acquisition section that acquires file management information, which is information for managing content files, the file management information having the managed content files registered therein and having an album defined therein, the content files being registered as one group in the album for management thereof;
an unregistered extraction section that extracts a content file as unregistered content file if, in the file management information, the album is defined by linking to another album in the album selected by a user, and further if a registered content file is also present in the album selected by the user; and
a virtual album registration section that creates a virtual album and registers the unregistered content file that is extracted by the unregistered extraction section into the created virtual album.
